(19) United States
(12) Patent Application Publication
(10) Pub. No.: US 2006/0218004 A1
(43) Pub. Date: Sep. 28, 2006

(54) ON-LINE SLIDE KIT CREATION AND COLLABORATION SYSTEM

(76) Inventors: Ross E. Dworkin, Springfield, PA (US); Charles A. Bono, Gwynedd Valley, PA (US)

Correspondence Address: WILLIAM H. EILBERG, THREE BALA PLAZA, SUITE 501 WEST, BALA CYNWYD, PA, 19004, US

(21) Appl. No.: 11/422,445

(22) Filed: Jun. 6, 2006

Related U.S. Application Data
(63) Continuation-in-part of application No. 11/087,404, filed on Mar. 23, 2005.

(51) Int. Cl. G06Q 99/00

(52) U.S. Cl. 705/1

(57) ABSTRACT

A slide kit is assembled with the collaboration of a number of reviewers who may be geographically separated. The slides are posted to a web site which is accessible by the reviewers. The reviewers post comments relating to particular slides. The comments are collated and considered, and a new version of the slide kit is prepared. A disposition diagram is also prepared, either explicitly or internally, to track changes to the slide kit from one version to the next. By keeping track of such changes, the system can associate the various comments with the correct slide, even though the slide numbers may have changed from one version of the slide kit to the next.

### CROSS-REFERENCE TO PRIOR APPLICATION

This is a continuation-in-part of U.S. patent application Ser. No. 11/087,404, filed Mar. 23, 2005.

### BACKGROUND OF THE INVENTION

This invention relates to the field of information management, and provides a system and method for creation and modification of slide kits for use in educational presentations or other fields.

Slides are frequently used in the delivery of oral presentations, whether in academic environments, in business, or in other fields. The term “slide” originally referred to a translucent photographic film that would move (“slide”) into position in a projector, for viewing on a screen. Modern technology has largely replaced the old photographic slide by a computer-generated image that is projected onto a screen.

Modern “slides” are typically created by known software programs, such as PowerPoint (the term PowerPoint is a trademark of the Microsoft Corporation, of Redmond, Wash.). The images created by these programs are still called “slides”, even though they are not photographic, and do not physically “slide” through anything.

In this specification, the term “slide” is used in its most general meaning, to include both conventional photographic slides, as well as computer-generated images. Indeed, in this specification, the term can refer to any display of information, whether the display is static or moving (such as a video), provided that that display can be handled as a unit, and placed in a series containing other similar or dissimilar units.

In various technical fields, the preparation of a set of slides, for use in an oral presentation, can be a substantial project. The slides will, in general, contain much technical material, which may be the result of considerable research, and which may include many facts, the details of which may be known only to a small number of experts.

For example, if the presentation is in the field of medicine, the set of slides used to illustrate the presentation may include much information that needs to be reviewed by a panel of physicians, scientists, and other experts.

The process of assembling and reviewing a set of slides can be difficult and time-consuming, not only because of the potentially large number of slides needed for a given presentation, but also because of the need to consult various experts, in geographically disparate locations, to insure the correctness and applicability of the slides.

The present invention provides an on-line system and method which greatly facilitates collaboration among a potentially large number of experts, in the assembly and review of slide kits. The invention also provides a system and method for keeping track of changes made to each such slide kit.

### SUMMARY OF THE INVENTION

The present invention comprises a method of creating a slide kit. According to this method, a set of slides is electronically accessed by a group of reviewers, who may be in the same location or in different locations. The reviewers may post comments relating to any or all of the slides, each comment being associated with a particular slide. The slides associated with each comment are collated, so that all comments made with respect to a particular slide can be viewed together. A facilitator, or editor, examines the comments, and assembles a modified set of slides, taking into consideration the comments received from the reviewers. In general, slides may be added, deleted, or modified, to produce the revised slide kit.

In another embodiment of the invention, the facilitator prepares a disposition diagram which illustrates the changes made to the slide kit, between one version and the next. This diagram links various slides in the original set with slides in the modified set. Thus, the facilitator can easily see which slides are common to both sets, and how the slides of the first set may have been renumbered in the modified set. The diagram also indicates which slides have been inserted or deleted when compiling the modified set.

The disposition diagram need not be shown explicitly, but could instead be internally generated, so that the system can automatically associate the various comments with the correct slide numbers in the modified slide kit.

The process of reviewing and modifying slide kits may be repeated one or more times, until the slide kit is in a desired form.

The process may include sending revised slide kits to all of the reviewers, or only to the reviewers who have suggested changes to any of the slides. Alternatively, the process may include sending, to the reviewers, only the slides that have been changed, to solicit further comment. In another alternative, slides may be sent to fewer than all of the reviewers, based on any other selection criterion.

In another embodiment, the invention permits reviewers to modify or replace slides, using appropriate slide-creation software. The system then provides a means for displaying a plurality of altered slides, as submitted by the reviewers, and gives the reviewers the opportunity to submit a quantitative rating for each slide, and to provide comments to be associated with each slide. A summary report, showing the altered slides, and showing the comments and ratings, from each reviewer, for each altered slide, can be presented to the facilitator and/or to other reviewers.

In another embodiment, the slide-creation and editing process is repeated so as to produce a plurality of different versions of the slide kit. All or some of these versions can be displayed together on a screen. In one preferred embodiment, the various versions are arranged in columns, and the system includes means for scrolling through each column, so that the facilitator or other user can quickly find and examine any slide of any version. The system allows the facilitator to click on a selected slide from a selected version, and the system then automatically finds other slides, in other versions, which appear to correspond to the selected slide. In this way, the system helps to automate the process of keeping track of changes in slides from one version to another.

In yet another embodiment, the system is programmed to “flag” all slides which have received a predetermined number of comments, but which have not been altered, and all slides which have been altered but which have received no comments. All slides meeting the above criteria are then presented to the facilitator, giving the facilitator the opportunity to check for errors or discrepancies in the slides.

A further embodiment of the invention allows a user to establish links between slides of different versions, or between slides of the same version. In establishing this “quick link”, the user specifies which slide(s) from which version(s) will become linked to the slide being reviewed. Then, whenever the selected slide is displayed, the display will include one or more icons, representing the links so established. When the user clicks on such a link, the user obtains detailed information concerning the linked slide. This feature allows users to establish links manually, apart from the automatic linking feature.

The invention also includes a system for practicing the above-described methods.

The present invention therefore has the primary object of providing a system and method for creating a slide kit for use in educational presentations or in other fields.

The invention has the further object of providing a web-based system and method in which a plurality of reviewers, who may be in geographically disparate locations, collaborate in the creation and modification of a slide kit.

The invention has the further object of providing automated, or semi-automated, graphical means for tracking changes to a slide kit, from one version to the next.

The invention has the further object of providing automated, or semi-automated, means for associating comments, made to a particular slide, with a correct slide number, even when the slide kit has been substantially modified.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a flow chart illustrating the basic steps in the method of the present invention.

FIG. 2 provides a diagram showing a typical screen, used in the present invention, illustrating a hypothetical slide, and showing the relevant comments made by various experts.

FIG. 3 provides a diagram which represents a typical screen, as seen by a facilitator or editor of a slide kit, in the preparation of slide kits according to the present invention.

FIG. 4 provides a diagram representing a screen viewed by the facilitator or editor of a slide kit, according to the present invention, the screen providing means for enabling the editor to document and track the changes made between successive versions of a slide kit.

FIG. 5 provides a diagram representing a display, viewed by the facilitator or editor of a slide kit, according to the present invention, the screen containing a diagram illustrating the changes made in successive versions of a slide kit.

FIG. 6 provides a diagram similar to that of FIG. 5, except that the diagram symbolically represents the slides of three successive versions of the slide kit.

FIG. 7 provides a diagram of a sample screen display, as shown to a user of the present system, according to another embodiment of the present invention.

FIG. 8 provides a diagram of a sample screen display, representing an advanced means for submitting comments to particular slides, according to the embodiment of FIG. 7.

FIG. 9 provides a diagram illustrating buttons on a screen display, in the embodiment of FIG. 7, allowing a reviewer to replace a slide or to add an altered slide.

FIG. 10 provides a diagram illustrating a screen display according to the embodiment of FIG. 7, the display containing different versions of the same slide, and allowing reviewers to rate or comment upon particular versions.

FIG. 11 provides a diagram illustrating a screen display according to the embodiment of FIG. 7, wherein comments and ratings, submitted by various reviewers, are collated and observed by a facilitator.

FIG. 12 provides a diagram illustrating a screen display according to another embodiment of the invention, for facilitating the tracking of slides from one version of the slide kit to another.

FIG. 13 provides a diagram illustrating a screen display, relating to the embodiment of FIG. 12, the display representing the result of clicking on an “enlarge” button in FIG. 12.

FIG. 14 provides a diagram illustrating a screen display, relating to the embodiment of FIG. 12, showing the use of automated linking of slides from different slide kits.

FIG. 15 provides a diagram illustrating a screen display presented to a facilitator in the present invention, showing the results of an analysis of slides of different slide kits.

FIG. 16 provides a diagram illustrating a screen display according to another embodiment of the invention, wherein the system marks for review all slides which have not been revised but for which there are comments.

FIG. 17 provides a diagram illustrating a screen display according to the embodiment of the invention wherein the system marks for review all slides which have been revised but for which there are no comments.

FIG. 18 provides a diagram illustrating a screen display relating to the embodiments of FIGS. 16 and 17, showing a summary of results as presented to a facilitator in the present invention.

FIGS. 19A, 19B, and 20-23 provide diagrams of hypothetical screen displays, illustrating the use of another feature of the present invention, wherein a user creates internal links among slides.

### DETAILED DESCRIPTION OF THE INVENTION

The present invention comprises a system and method for on-line collaboration in the creation of slide kits. The term “creation”, as used herein, refers to the process of selecting slides for inclusion in a slide kit, reviewing such slides, and arranging the slides in an optimum order. The present specification does not provide details concerning the actual creation of individual slides, as it is assumed that the user of the system has the available software (such as Microsoft PowerPoint or its equivalent) to create the slides.

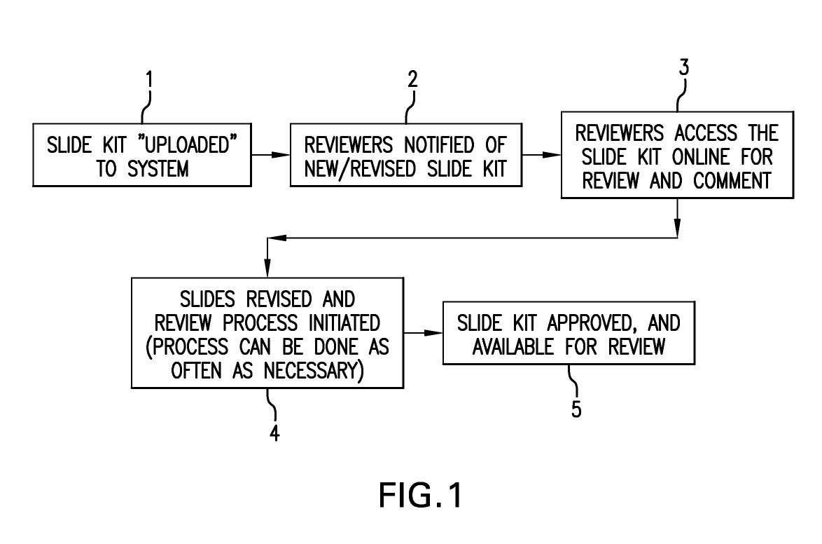

FIG. 1 provides a flow chart that shows the basic steps of the process of the present invention. In block 1, a slide kit is uploaded to a computer memory, such that the kit becomes accessible to a plurality of reviewers. Preferably, the computer memory comprises an Internet web site which can be accessed by the reviewers through an ordinary Internet connection.

In block 2, the reviewers are notified of the availability of the slide kit that has been uploaded to the system. In general, the reviewers may be any set of persons who have been designated to provide feedback on the contents of the slide kit. In practice, the reviewers may be selected experts in the field to which the slide kit pertains. The notification of the reviewers may be by telephone, by fax, by email, or by any other means. In general, the reviewers may be located in geographically disparate places, but some or all of the reviewers could be in the same place.

In block 3, the reviewers access the web site containing the slide kit, and review the slides. The system allows each reviewer to enter comments on each slide. The various reviewers need not review the slides simultaneously. In general, since the reviewers may be located in different places, they will likely access the slide kit at different times. Each reviewer will provide his or her feedback, preferably by typing comments onto a provided field on a screen display of the web site. Such typed comments later become available for review by a facilitator or editor of the slide kit, as well as by other reviewers. The system electronically associates these comments with the slide being viewed by the reviewer. Thus, with every comment, there is associated a number which represents a slide in the slide kit being reviewed.

In block 4, the slide kit is revised by the facilitator or editor, preferably taking into account some or all of the comments made by the reviewers. This revision step could include the creation of entirely new slides, or the creation of new slides which comprise modifications of slides of the previous set, using known software as described above. The revision step could also include altering the order of slides in the kit, and/or eliminating individual slides entirely. When the slide kit has been revised, the editor uploads the new kit onto the web site. In block 5, the slide kit has been approved, and is available for review.

The invention includes several variations in the process of making a revised slide kit available to the reviewers. For example, the system can enable the facilitator to make specific slides accessible by particular reviewers. Thus, the facilitator would be able to direct a modified slide only to the reviewer(s) who need to review that slide.

In another variation, the system can be programmed to make slides selectively available to some or all of the reviewers, by automated means. For example, the system can be set so that only slides that have been commented on are uploaded and available to be seen by the reviewers. Or the system can be set so that only those reviewers who have suggested changes to any of the slides will see some or all of the revised slides. Also, the facilitator could set the system manually, so that the revised slides are made available to individually selected reviewers, the selected reviewers being chosen according to any criterion. In general, the system can be programmed to make slides available to a group of reviewers, wherein such group comprises fewer than all of the available reviewers.

The above-described variations are optional, and if they are desired, they can be used singly or in any combination. Block 4 is therefore intended to include any or all of these variations.

The process represented by the flow chart of FIG. 1 may be repeated one or more times. Thus, in general, the slide kit that is uploaded in block 1 may be an entirely new set of slides, representing the first iteration of the process, or it may be a modified version of a set of slides that has been reviewed previously. The process of review and modification of the slide kits can proceed through as many iterations as desired. Eventually, the process reaches a stage at which the reviewers have no further comments or suggestions.

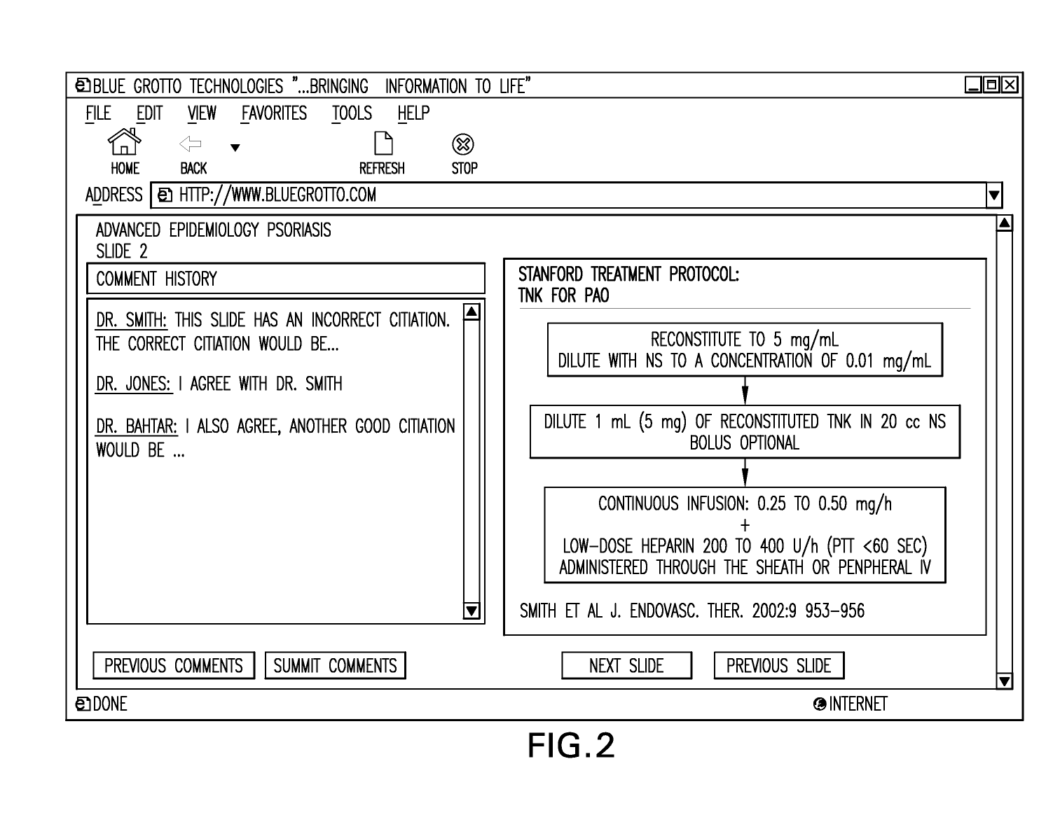

FIG. 2 shows a typical screen display that is accessible by the reviewers participating in the creation of the slide kit. This display embodies the process step described in block 3 of FIG. 1. A hypothetical slide is shown on the right-hand side of the display in FIG. 2. In this hypothetical example, the material shown in the slide is taken from a journal article, the citation of which is shown at the bottom of the slide. The slides may, in general, have any format, and the invention is not limited by the content or format of the slide.

The left-hand side of the display of FIG. 2 contains a set of comments, each comment being associated with the name of the reviewer who submitted it. The comments shown on the display are associated with the slide shown on the right-hand side.

The screen in FIG. 2 provides buttons, at the bottom, to enable the reviewer to control the slides being viewed. In particular, there is a “next slide” button and a “previous slide” button, which enables the reviewer to advance to the next slide in the set, or to return to the previous slide. When the reviewer clicks one of these buttons, the slide displayed on the right-hand side changes accordingly, showing the next slide or the previous slide in the sequence comprising the slide kit.

The reviewer can submit comments on a particular slide by clicking the “submit comments” button. The reviewer would then be presented with an appropriate interface (not shown) for entering a comment. That comment would then be associated with the slide shown on the right-hand side, and would be visible in the comment history, shown on the left-hand side. The reviewer could also see comments pertaining to previous slides by clicking the corresponding button.

The screen shown in FIG. 2 could also include an “approve” button, which could be used, by the reviewer, to signal approval of a particular slide.

In the embodiment represented in FIG. 2, one reviewer is permitted to view all of the comments made by the other reviewers. In an alternative arrangement, the system could be designed such that each reviewer can only view his or her own comments. In the latter case, the facilitator or editor would normally be the only person allowed to view all comments.

The interface represented in FIG. 2 is only one way of implementing the present invention. Other screen displays could be designed, which perform substantially the same function as that of FIG. 2, but which may have different appearances. All such modifications are intended to be encompassed by the present invention.

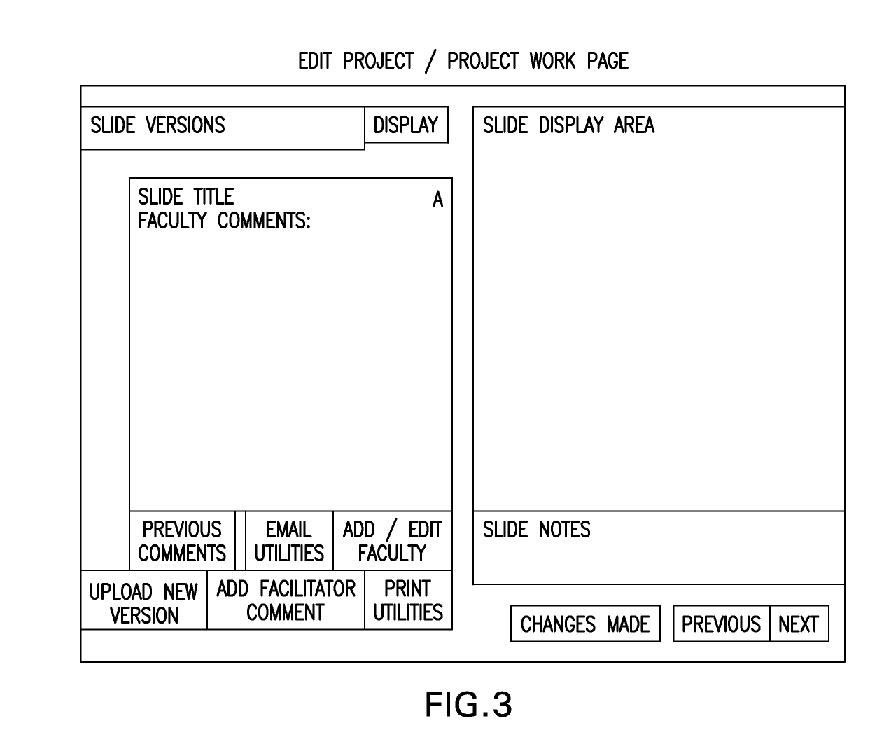

FIG. 3 provides a diagram of a display screen that is used by the facilitator or editor of the slide kit, according to the present invention. In this specification, the terms “facilitator” and “editor” are used interchangeably. This screen enables the editor to perform the basic tasks associated with the editing of the slide kit.

The box labeled “Slide Versions” indicates the slide kit versions that have been uploaded to the web site. Preferably, each version is identified by a number (not shown). The editor can load a selected version by selecting the version by number. The “Display” button causes the selected version of the slide kit to be loaded into the slide display area. The slide display area preferably shows one slide at a time, from the selected version of the kit. The facilitator uses the “Previous” and “Next” buttons to navigate among the slides in the slide kit. These buttons permit the facilitator to move forward or backward in the set of slides.

Thus, when the facilitator selects a numbered version of the slide kit, the facilitator sees a particular numbered slide on the right-hand side of the display, coupled with the comments made to this slide by the reviewers. The left-hand side of the display indicates the title of the slide, and reproduces all comments that may have been made by any of the reviewers. The system can be programmed to display all previous titles of the same slide, if the title has been modified.

The button labeled “Previous comments” allows the editor to view comments pertaining to this slide, which comments were made relative to a prior version of the slide kit.

The button labeled “Email utilities” allows the editor to email comments to one or more of the group of reviewers.

The button “Add/edit faculty” allows the editor to change information regarding a member of the group of reviewers, or to add or delete reviewers.

The button labeled “Upload New Version” enables the editor to upload a new version of the slide kit, to the web site, for review by the panel of reviewers.

The button labeled “Add facilitator comment” enables the facilitator to add comments to the particular slide shown in the display area.

The button labeled “Print Utilities” provides access, to the editor, to various utilities which allow printing of various reports. For example, the system can be programmed to print a report of every slide in the kit, or of every slide having comments associated therewith, or of other subsets of the slides, based on selected criteria. The printed reports may also include data on system and reviewer usage.

The area labeled “Slide notes” displays the notes associate with the displayed slide. These notes are created by the software (such as PowerPoint) which is used to create the slide, and are not created by the present program or by the editor. Thus, the notes shown in this area can be changed only by making a new slide.

The button labeled “Changes made” enables the editor to provide comments concerning the changes made to a particular slide. These comments can then be read by the reviewers.

The example of FIG. 3 can be modified to accommodate the variations described above with respect to block 4 of FIG. 1. For example, the display may include a button which enables the facilitator to designate a slide as one to be reviewed, thus allowing that slide to be posted again to the web site for further access by the reviewers. The display may include a button and window that allow the facilitator to identify the reviewer(s) who will have access to the indicated slide, and thereby limit the display of the slide to particular reviewers. Also, the display may include buttons that enable the facilitator to select the options of 1) displaying, to reviewers, only slides that have been modified, and/or 2) displaying slides only to reviewers who have suggested changes.

Thus, the present invention should not be considered limited to the specific example represented in FIG. 3. Many alternative ways of displaying the data could be used, and the buttons could be configured differently.

An important aspect of the present invention is the ability to track changes made to the slide kit. During the review process, slides may be added, deleted, and/or moved. A given slide may have a certain number in one version of the slide kit, and another number in a later version. In general, tracking such changes can become overwhelmingly difficult, especially where the number of slides in the kit is moderate or large, and where the kit has been modified many times.

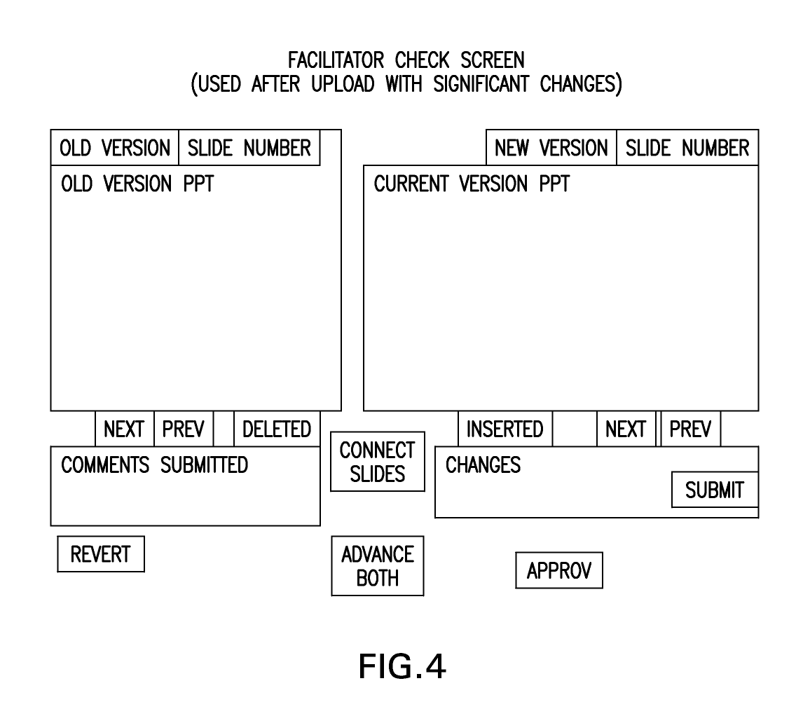

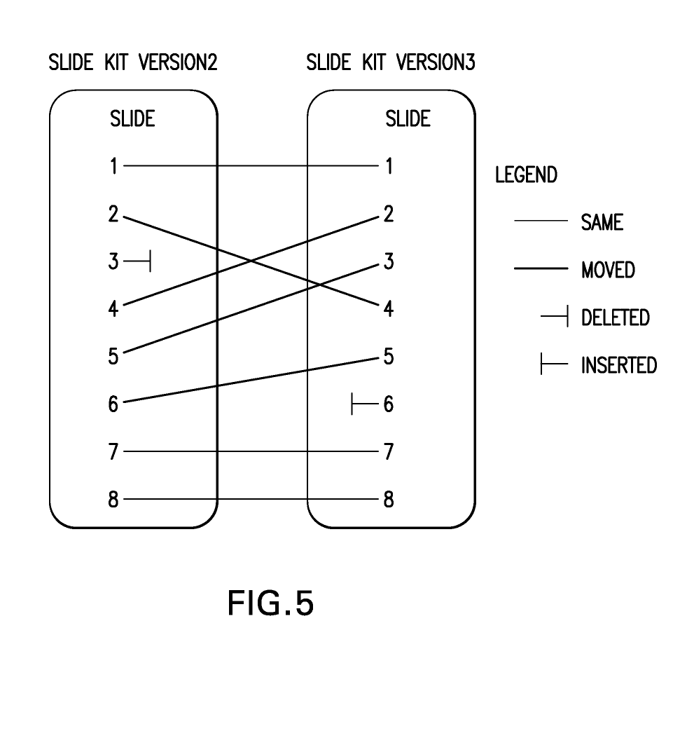

FIG. 5 provides an example of a diagram, for a simplified hypothetical case, generated by the system of the present invention, to show the facilitator or editor the disposition of slides between one version and the next. FIG. 4 provides a sample display screen which the facilitator or editor would use to track the changes, and to generate a diagram of the type shown in FIG. 5.

In the simplified example represented by FIG. 5, Version 2 of a slide kit contains eight slides, and Version 3 of the slide kit contains eight slides. Of these slides, Slide Nos. 1, 7, and 8 are the same in both versions, and occupy the same relative positions in the respective kits. However, Slide 2 of Version 2 has become Slide 4 of Version 3. Slide 3 of Version 2 has been deleted. Slide 4 of Version 2 has become Slide 2 of Version 3, and Slide 5 of Version 2 has become Slide 3 of Version 3. Slide 6 of Version 2 has become Slide 5 of Version 3. Slide 6 of Version 3 is new, and was not included in Version 2. A legend on the right-hand side of FIG. 5 shows the interpretation of the symbols used in the figure, to indicate the disposition of each slide.

FIG. 4 shows the screen used by the facilitator to keep a record of the changes between versions, i.e. to generate the diagram shown in FIG. 5. The space on the left-hand side labeled “Old Version” is used to display slides from the old version, and the space on the right-hand side labeled “Current Version” is used to display slides from the new version. The slide number of each slide, for the respective versions, are shown in the small blocks above the main displays for both sides. Thus, the large areas on the left and the right are used to display one slide at a time, from the old version (left-hand side) and from the new version (right-hand side).

For example, if the small blocks on the upper left-hand side indicate “Old version, Slide Number 3”, the “Old Version” screen on the left-hand side would show Slide No. 3 of the old version, and so forth. Similar nomenclature is used on the right-hand side, with respect to the slides of the new version.

By clicking the button “Connect Slides”, the facilitator or editor creates a link between the slide on the left-hand side and the slide on the right-hand side. More particularly, the “Connect Slides” function is precisely what creates the lines shown in FIG. 5, which lines indicate which slide from the old version corresponds with which slide from the new version.

The facilitator can scroll through the sequence of slides in the old version and in the new version, by clicking the buttons marked “Next” and “Prev”, for either or both sides of the display. That is, the facilitator navigates through the list of slides, of either or both versions, moving to the next slide, or the previous slide, by clicking on the appropriate buttons. When the slide shown at the left is intended to correspond to the slide shown on the right, the facilitator may click “Connect Slides” to create the solid line that will be shown in the diagram illustrated in FIG. 5.

The button “Deleted”, on the left-hand side, can be used to identify a slide, from the old version, as having been deleted. Activation of this button will cause a “deleted” symbol to appear in the diagram of FIG. 5. In the example given, Slide 3 of the old version has been deleted.

Similarly, the button “Inserted”, on the right-hand side, can be used to identify a slide, from the new version, as having been inserted. Activation of this button will cause an “inserted” symbol to appear in the diagram of FIG. 5. In the example given, Slide 6 of the new version has been inserted.

By clicking the button labeled “Advance Both”, the displays of both the left-hand side and the right-hand side advance to the next slide in the respective series. This button therefore enables the facilitator to advance the slides in both versions with a single click, avoiding the need to advance the slides separately for the two versions.

The area labeled “Comments submitted” displays the comments made by the reviewers, to the slide shown in the display area of the old version. The area labeled “Changes” is for use by the facilitator, in listing the changes reflected in the new version.

The “Approve” button is used to allow the facilitator to signal approval of a revised version. The “Revert” button is used to eliminate the new version on the web site, and to allow the facilitator to make changes and upload a new version again.

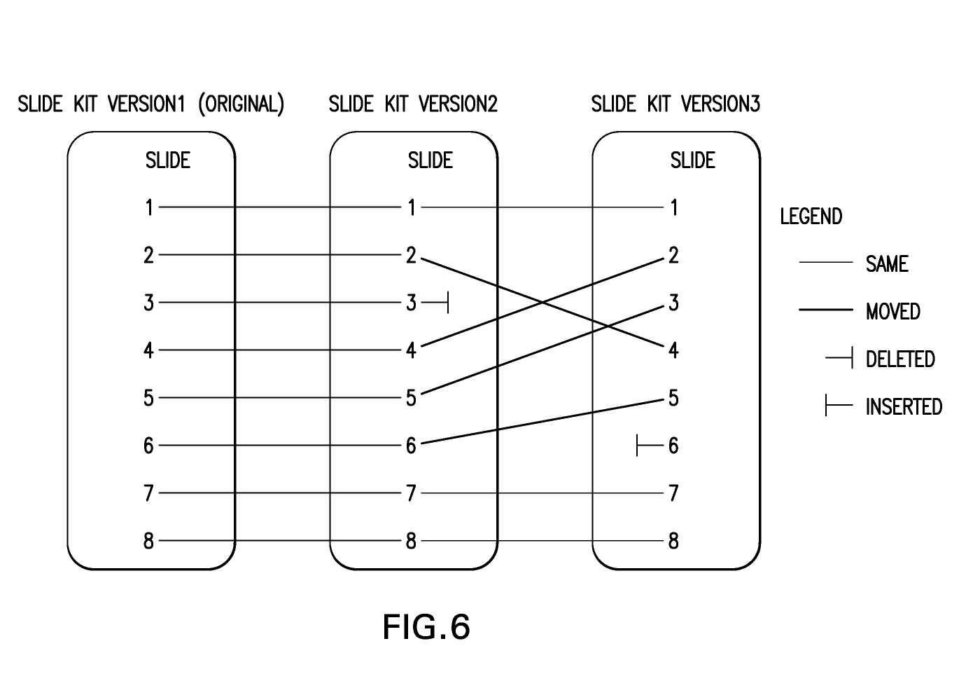

FIG. 6 shows an alternative display constructed according to the present invention. FIG. 6 symbolically represents three successive versions of a slide kit, and shows the disposition of slides from one version to the next. In the example of FIG. 6, the slides of the first version are in one-to-one correspondence with the slides of the second version, but in general, the slides could be inserted, deleted, or moved, just as was done between Versions 2 and 3. The display of FIG. 6 gives the facilitator more complete information about the disposition of slides, by enabling the viewing of three versions at once.

If the embodiment of FIG. 6 is used, it is still preferred that the display of FIG. 4 show only two versions at one time. The reason is that FIG. 4 represents a screen by which the facilitator indicates changes from one version to the next, whereas FIGS. 5 and 6 simply summarize the changes that have already been made. To minimize confusion, and to reduce clutter on the screen, it is desirable that FIG. 4 show only two successive versions at a time.

The method of the present invention is therefore practiced as follows. A group of reviewers, such as a panel of experts in the relevant field, is selected. These reviewers may be located in one place, or in different places. An initial set of slides is selected, and is posted to a web site, or equivalent on-line facility, allowing the reviewers to examine the slides. The reviewers post comments and/or suggestions relating to any or all of the slides, and in one embodiment, all reviewers can see the comments made by the other reviewers, and may post further comments in response, if desired. Each comment is automatically associated with the slide that was being displayed to the reviewer when the reviewer entered the comment. The comments are collated so that each slide, in general, is associated with a plurality of comments. A facilitator or editor reviews all of the comments, and compiles a revised slide kit, taking the comments into consideration. The process is repeated, as the facilitator posts the new version to the website for further review by the panel.

Comments by the reviewers may be made during a specified time interval or “window”. That is, the reviewers may be notified that a slide kit is available for review, and that comments, if made, must be submitted on or before a certain deadline. Thus, the comments can be made by many reviewers, at different times during this time “window”.

When each new version of the slide kit is produced, the facilitator also preferably constructs a diagram showing the disposition of each slide, from one version to the next, and accounting for slides that were deleted and slides that were added. The diagram is constructed with the help of a computer program which facilitates the generation of visual connections between selected slides.

In addition to providing a visual indication of the history of the various slides, the information on disposition of each slide can be used as follows. In general, each comment received from a reviewer is associated with a particular slide number. When the slide kit is modified, many of the slide numbers change. It is therefore necessary, and important, that the comments be keyed to the appropriate slide. A comment to “Slide 4” of a given kit may need to be labeled as a comment to a slide having a different number, in a later version. The disposition diagram of FIG. 5 enables the facilitator to keep track of the changes, and to revise the slide numbers so that each comment is associated with the intended slide.

If the slide kit is large, and/or if the kit undergoes many revisions, the task of keeping track of the disposition of the slides may be very difficult. It is therefore within the scope of the present invention, that the system could be programmed to revise all slide numbers mentioned in a set of comments, in accordance with the disposition information generated.

For example, suppose that FIG. 5 represents the disposition of slides between one version and the next. The system can be programmed to scan each comment. As noted above, each comment is associated with a particular slide number, because the comments are made while the reviewer is viewing a particular slide (as represented in FIG. 2). Thus, the system can be programmed to examine each slide number, from 1 to 8. For comments associated with slide No. 1, no changes are made. For comments associated with slide No. 2, the comments are now associated with slide number “4” in the modified set, because slide No. 2 has been changed to slide No. 4 in the modified set. Comments associated with slide No. 3 are ignored, because that slide is deleted. For comments associated with slide No. 4 in the original set, the comments are now associated with slide No. 2 in the modified set, and so on.

It should be appreciated that the comments themselves need not be changed. What is important is that the comments are associated with the correct slides. When the order of a particular slide is changed, in a modified slide kit, the comments associated with the slide in the original set must be re-associated with the appropriate slide of the modified set. The diagram of FIG. 5 shows how these associations are made.

Thus, FIG. 5 represents not only a graphical representation that can be viewed, and used, by a human facilitator, but it also represents a table that can be internally generated and stored, and used by the system to update the comments by changing the slide numbers associated with some or all of the comments. That is, it is not necessary to display the information represented by FIG. 5, but that information could be used, automatically, to renumber the comments associated with the slides. Thus, the invention can be described as either semi-automated (wherein the human facilitator generates and views the disposition diagram) or automated (wherein the system generates the information and modifies slide numbers accordingly).

Another variation of the invention is the use of codes which are electronically associated with each slide. When a slide kit is created, an electronic code or tag is applied to each slide in the kit, in a manner consistent with the format of the program being used (such as PowerPoint). For each new revision of the slide kit, the computer program implementing the present invention would track these codes or tags. Each code or tag is unique to a particular slide.

After a new version of the slide kit has been prepared, the program could scan all of the codes of the slides of the new version. Because each code is unique to a particular slide, the program could easily determine which slides have been inserted, which have been deleted, and which have been moved. Thus, by examining all of the codes associated with slides in one version and in the next version, and comparing the codes appearing in both versions, the program could automatically generate diagrams such as those of FIGS. 5 and 6, or could store equivalent information in memory, all without the need for a human facilitator to indicate dispositions. That is, the manual steps represented by FIG. 4 would not be necessary, as the dispositions of slides could be tracked automatically.

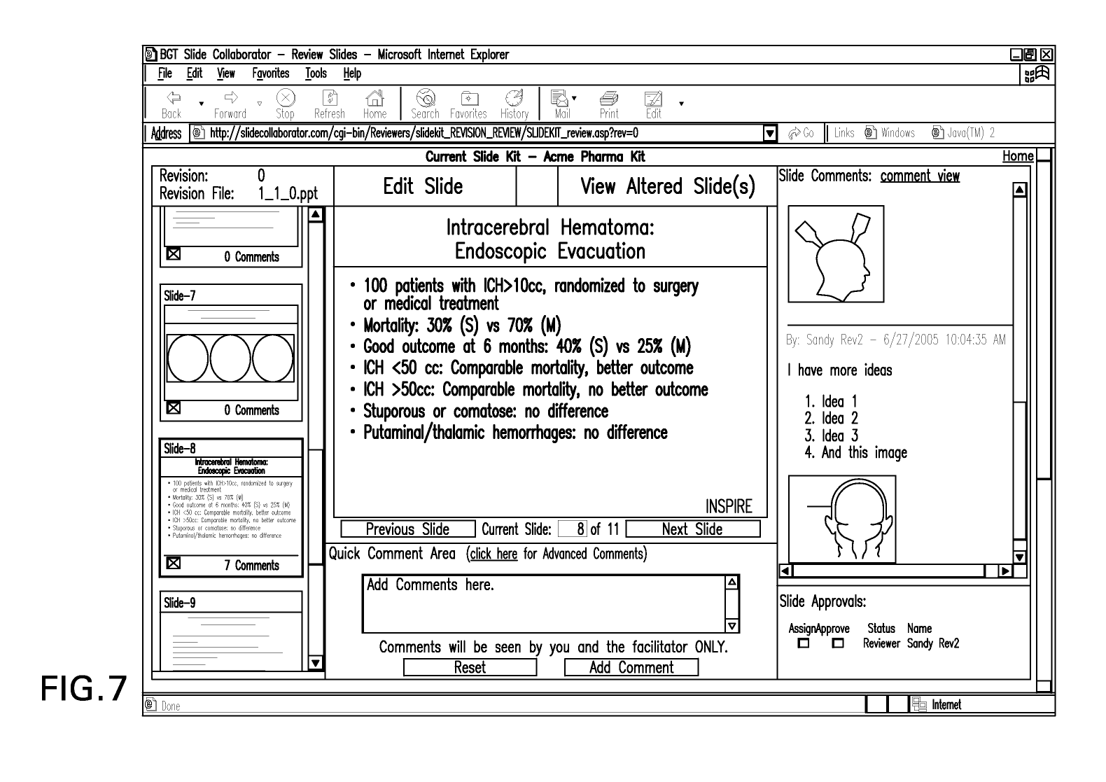

FIGS. 7-11 illustrate an alternative embodiment of the present invention. FIG. 7 represents a typical screen display as viewed by one of the reviewers. The title bar near the top of the display shows the title of the slide kit being reviewed (“Acme Pharma Kit”). The slides of this kit are shown in the left-hand column, through which the reviewer can scroll. When the reviewer clicks on a desired slide, the image of the slide, in the left-hand column, becomes highlighted, as is shown in FIG. 7, and the full slide is displayed in the central window. In the example shown, the reviewer has clicked on Slide 8, which is shown in more detail in the large central window.

The reviewer may navigate through the slide kit either by scrolling through the left-hand column and selecting a desired slide, or by using the “Previous Slide” or “Next Slide” buttons below the central display. An indicator shows which slide is currently being viewed. In the example shown, the indicator shows that the slide being displayed, i.e. the “Current Slide”, is number 8 of 11.

The reviewer has the opportunity to insert comments in two ways. First, the reviewer may simply type a textual comment, in the “Quick Comment Area”. The reviewer types the comment in the block marked “Add comments here”. The comment is permanently recorded by the system when the reviewer clicks the “Add Comment” button.

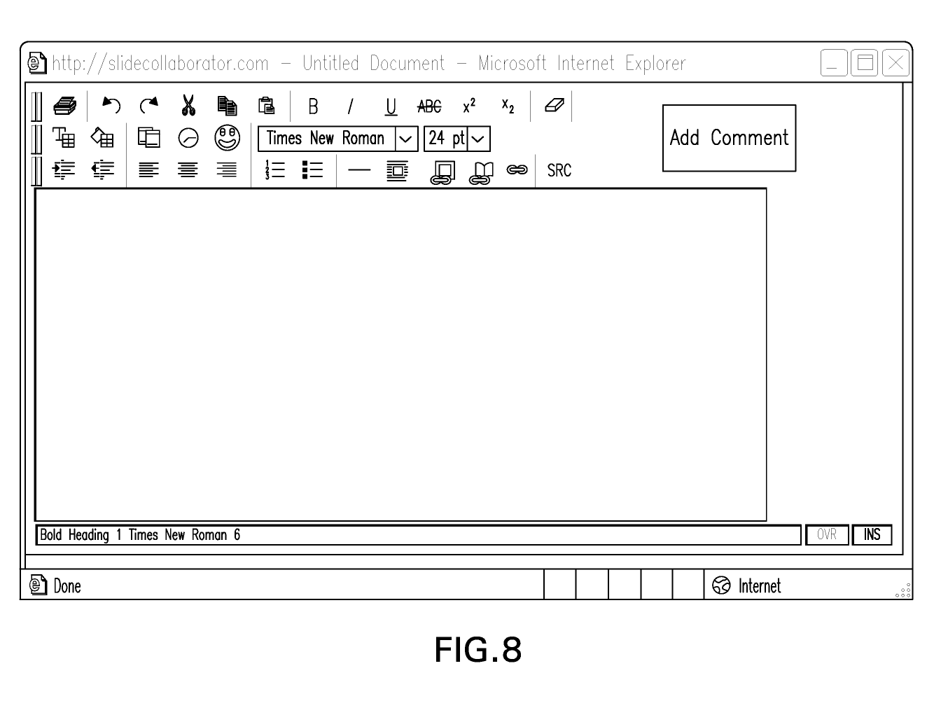

Alternatively, the reviewer may click on the indicated link for “Advanced Comments”. The reviewer will then be presented with a screen display such as is shown in FIG. 8. This screen allows the reviewer to insert comments in the form of text, or images, or both. Clicking on the “Add Comment” button causes the system to record the comment, and to associate the comment with the selected slide. The system then returns the reviewer to the screen represented in FIG. 7.

In FIG. 7, the comments associated with the selected slide are shown in the right-hand column. The reviewer can scroll through all of these comments, using the scroll bar on the right-hand side. Note that the comments may comprise text, or images, or combinations of text and images, as explained above and as illustrated in FIG. 7. When a different slide is selected, the comments shown on the right-hand side will change, such that only the comments associated with the new selected slide will be shown.

The “Reset” button in FIG. 7 allows the reviewer to erase a comment before it has been recorded. The block at the lower right-hand corner of FIG. 7 allows the facilitator to indicate approval of a slide.

The reviewer has the opportunity to submit an altered version of the selected slide. To do so, the reviewer clicks “Edit Slide”, which causes the selected slide to be loaded into a standard slide-creation program. For example, if the slide was created by PowerPoint, clicking on “Edit Slide” loads the resident version of PowerPoint, and loads the current slide, so that the reviewer can edit the slide within the PowerPoint program. The present invention is not limited to use with PowerPoint, and any other slide creation program could be used instead. The details of the step of editing the slides, or the creation of new slides, is not part of the present invention, because the actual creation and modification of slides is performed using existing slide-creation software. Also, such creation, modification, or editing could be performed by a graphic imaging program which may reside on the reviewer's computer, or on the host system.

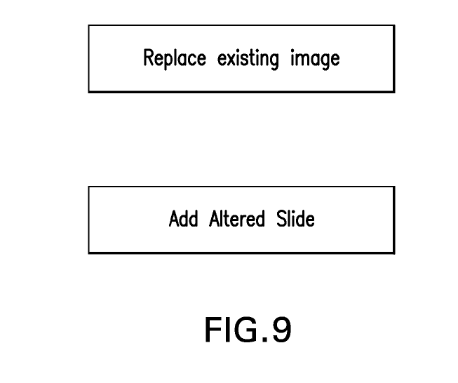

When the reviewer has finished the process of modifying a slide, the system provides the choice, indicated by the buttons represented in FIG. 9, of replacing the existing slide or of adding the altered slide to the kit. If the reviewer clicks on the button labeled “Replace existing image”, the selected slide is replaced by the edited version. However, it is preferred that the system retain, as a backup, a copy of the selected slide before it was edited. If the reviewer clicks the button labeled “Add Altered Slide”, the edited version is added to the present version of the slide kit.

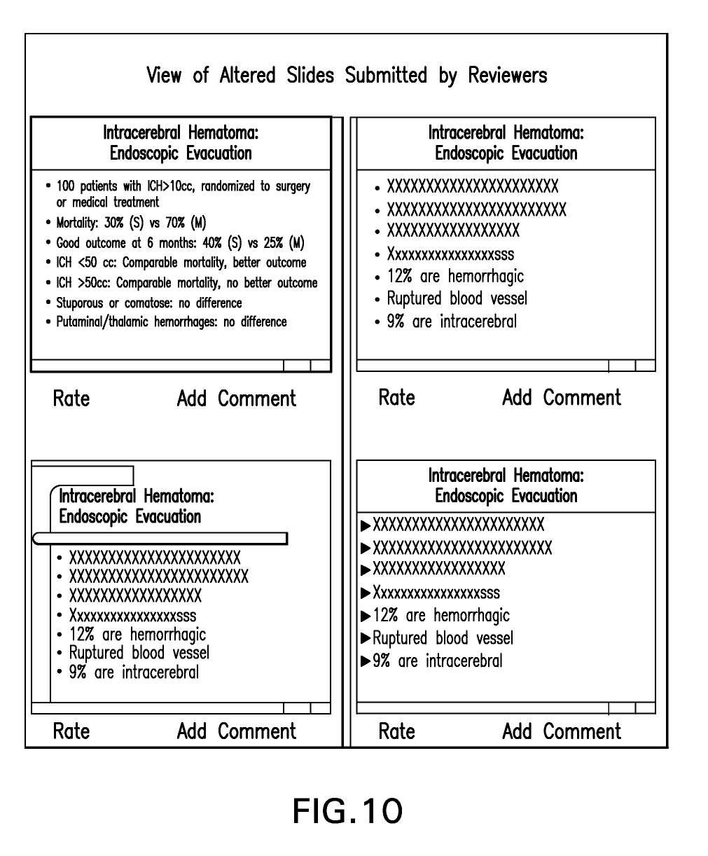

The reviewer may view all of the altered slides corresponding to the selected slide, by clicking on the button labeled “View Altered Slide(s)”, in FIG. 7. The result is as shown in FIG. 10. FIG. 10 represents a display of the original version and three altered versions of the selected slide (Slide 8) of FIG. 7. The original version is shown in the upper left-hand corner. In the example given, the other versions of the slide are all identifiable as variations of the same slide, but each has been altered in a different way.

Below each image in FIG. 10, there are buttons or links labeled “Rate” and “Add Comment”. By clicking on “Rate”, the reviewer may submit a rating, i.e. a quantitative indication of merit, for a particular slide. For example, the reviewers may be asked to rate each slide on a scale from 1 to 10. By clicking on “Add Comment”, the reviewer may comment on a particular version of the slide, and the comment will be recorded by the system, and associated internally with the selected slide. In general, the latter comments will not be displayed in FIG. 7 unless the altered version has been formally added to the slide kit in the manner described above.

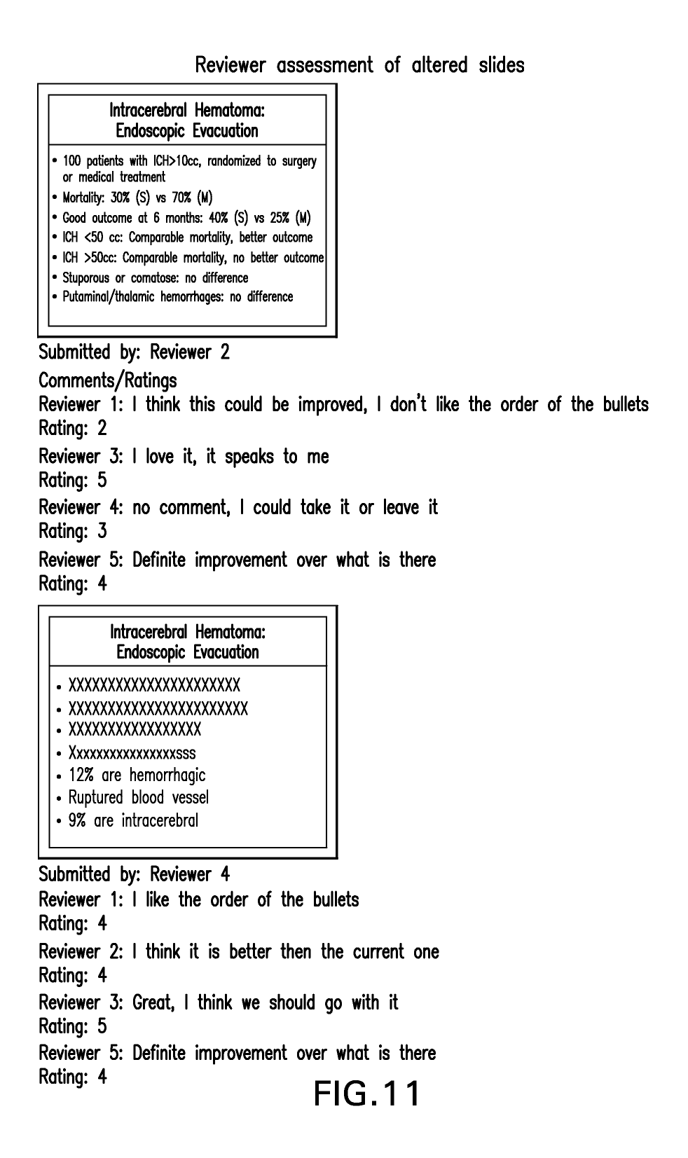

FIG. 11 depicts a display presented to the facilitator according to the embodiment of FIG. 7. As shown in FIG. 11, the system collates the comments and ratings on each version of a slide, submitted by the various reviewers, and allows the facilitator to see which reviewer submitted which version, and to see the comments and ratings of each reviewer with respect to each particular slide.

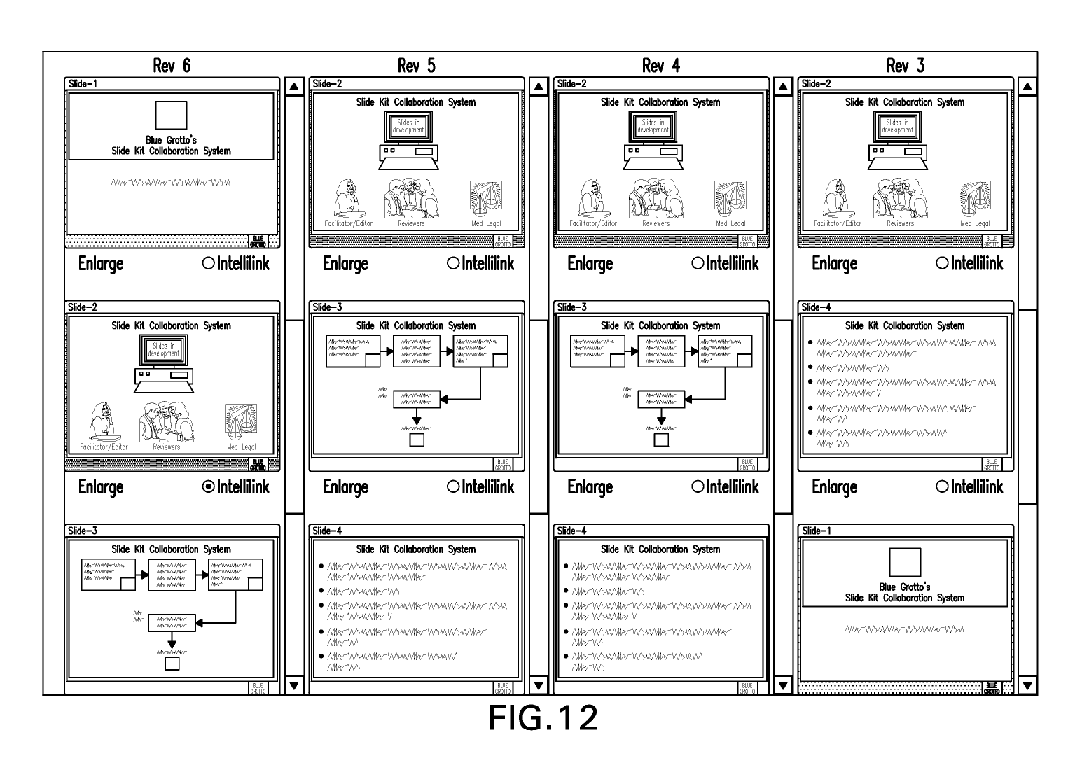

FIG. 12 illustrates another embodiment of the invention, wherein the system helps to automate the process of tracking the disposition of slides from one version to another, and of creating internal links among similar slides. FIG. 12 represents a sample screen display, in which a series of versions of the slide kit, designated “Revision 3”, “Revision 4”, etc., are arranged in columns on the screen. The facilitator may scroll through any of these columns to locate and examine any desired slide in a particular version of the kit. In the example given, there are three slides from each kit visible at one time.

Below the image of each slide, in FIG. 12, there is a button labeled “Intellilink”, which is an abbreviation for “intelligent linking”. When the facilitator clicks on the Intellilink button on a slide from any version, the system automatically examines all slides of all of the other versions, and determines which slides, if any, from the other versions, correspond to the selected slide. As used in this embodiment, the term “correspond” means that the slides share a sufficiently large proportion of features such that the slides can be recognized as alternate versions of the same slide.

For example, as shown in FIG. 12, the second slide of Revision 6 corresponds to the first slide of each of Revisions 3, 4, and 5. The third slide of Revision 6 corresponds to the second slides of each of Revisions 4 and 5, but appears to have no analog in Revision 3. The first slide of Revision 6 corresponds to the third slide of Revision 3, but has no visible analog in Revisions 4 and 5.

When the system finds slides in other versions, which correspond to the slide selected from a given version, the system highlights those corresponding slides, such as by displaying those slides with shading. In FIG. 12, the various versions of Slide 2 of Revision 6 are indicated by the shaded area below the slides. The system also records the correspondences internally, so as to track exactly the history of each slide.

The algorithm for determining correspondences between slides of different versions can be constructed in various ways. For example, the algorithm could be simply a pixel-by-pixel comparison of images, the system being programmed to perform a least-squares comparison, or cross-correlation, or other comparison, between images. A pair of images which yield a minimum value of a comparison function, such as a least-squares function or its equivalent, could be deemed “similar”. Alternatively, the image could be divided into fields or segments, and the system could be programmed to compare images by examining such fields or segments, and to identify corresponding slides according to the degree to which the segments match each other. In another alternative, the images could be compared by searching for the presence of similar words, or similar objects, or any other point of similarity. All such techniques are included within the scope of the present invention.

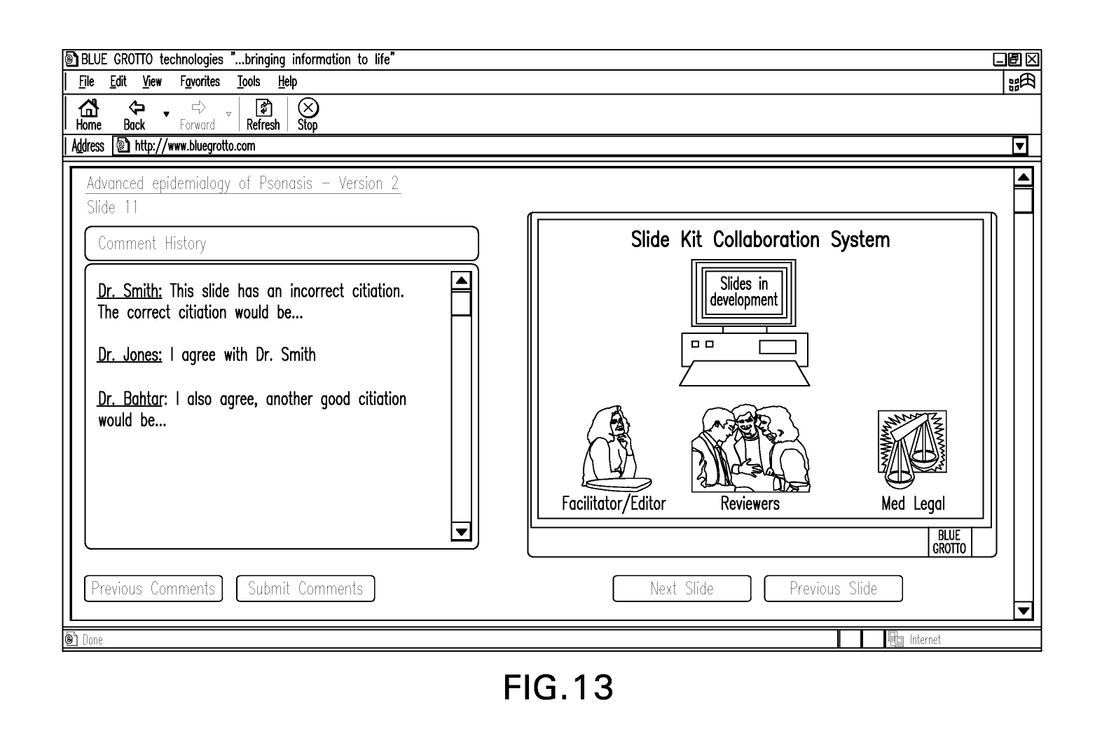

The system also allows the facilitator to view any slide, of any version, in more detail, by clicking on the “Enlarge” button in FIG. 12. When the facilitator does so, the result is as shown in the example given in FIG. 13. FIG. 13 shows the selected slide, together with all comments associated with the slide. The interface illustrated in FIG. 13 also allows the user to navigate to the next slide or the previous slide, and to view previous comments or to submit new comments.

In the preferred embodiment, the system generates candidate slides to be linked, based on the algorithm described above. The facilitator can then make the final decision about whether the slides indeed correspond to each other, and whether they should be linked.

The concept of intelligent linking of slides applies not only between slides of different versions of a single slide kit, but also between slides of different kits. In practice, the same slide may often be used in two or more entirely different kits.

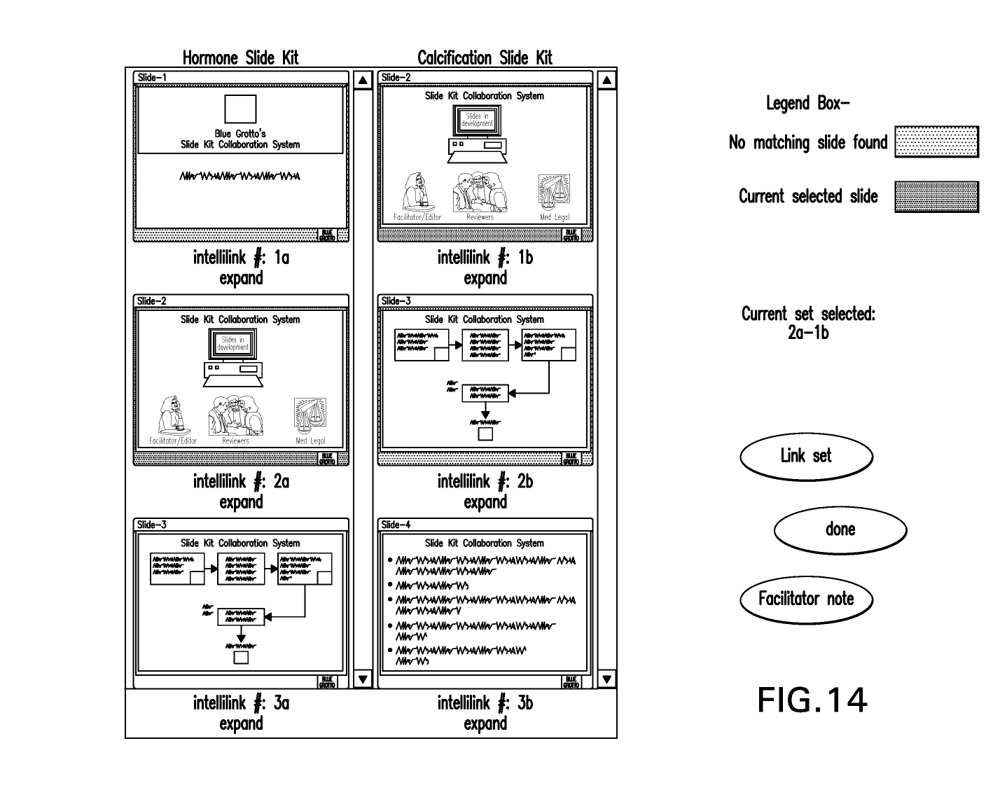

FIG. 14 provides an example wherein two slide kits, one labeled “Hormone Slide Kit” and the other labeled “Calcification Slide Kit”, are displayed in a manner similar to that of FIG. 13. In this simplified example, Slide 2a of the Hormone kit corresponds to Slide 1b of the Calcification kit. When the facilitator selects Slide 2a and clicks the Intellilink button, the system finds a correspondence with Slide 1b, and highlights the slides, using the shading shown in the legend, to indicate such correspondence. The facilitator can then create a formal link, i.e. save internally the correspondence between these slides, by clicking the “Link set” button. On the other hand, when the facilitator clicks on Slide 1a, the system is unable to find a corresponding slide from the other kit, and the shading indicates that no matching slide was found. The facilitator can use the “Facilitator note” button to add notes, and the “Done” button is used to exit the program.

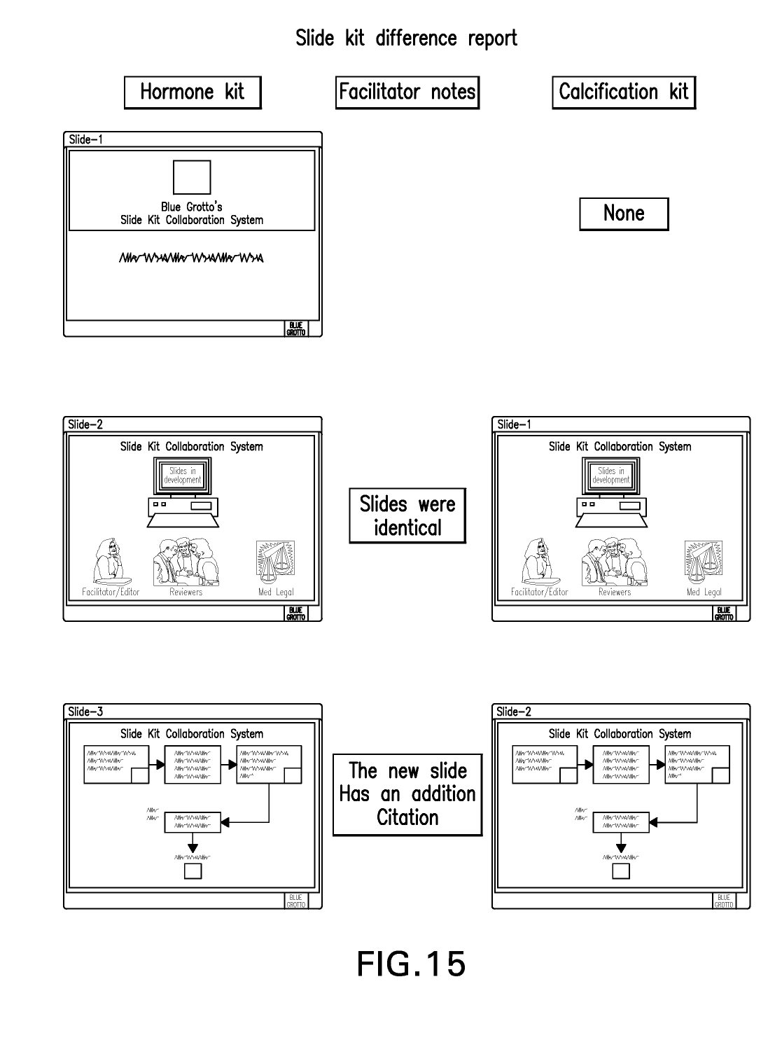

FIG. 15 illustrates a sample report that is presented to the facilitator, after the facilitator has created links between slides of different slide kits, and has commented on some or all of the slides. In the example of FIG. 15, Slide 1 of the Hormone kit has no corresponding slide in the Calcification kit. Slides 2 and 3 of the Hormone kit correspond, respectively, with Slides 1 and 2 of the Calcification kit. The facilitator has inserted comments with respect to Slides 2 and 3 of the Hormone Kit only. Note that the same kind of report could be generated in the case where the comparison is made between different versions of the same kit, instead of different kits.

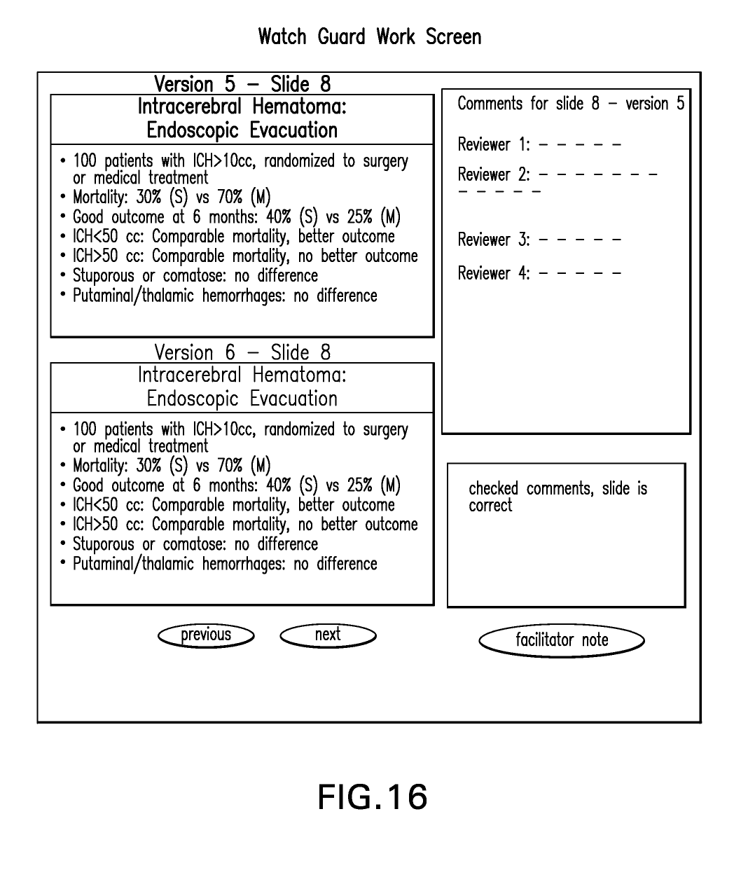

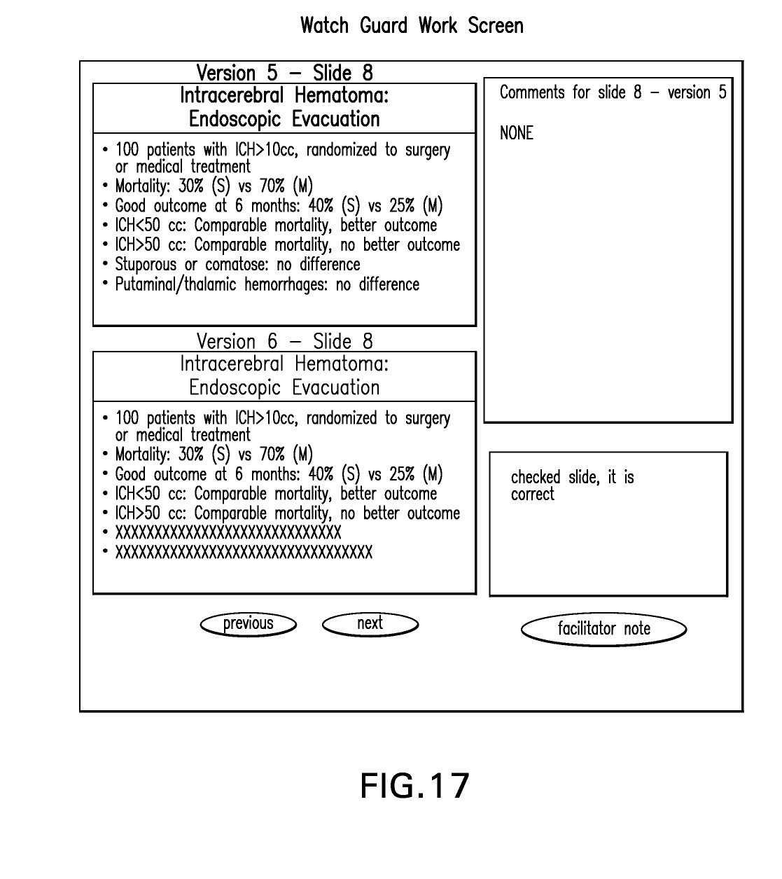

FIGS. 16 and 17 illustrate another embodiment, wherein the system is programmed to notify the facilitator of the following two situations. First, the system places a notation on all slides for which there were some predetermined number of comments but no changes to the slide were made. Secondly, the system places a notation on all slides which were changed, but for which there were no comments made. In both cases, the notation is preferably an internal “flag”, which causes the flagged slides later to be brought to the attention of the facilitator. These flags can be placed with regard to comparisons between specific selected versions of the slide kit. For example, the facilitator may view all flags generated as a result of a comparison between Version 2 and Version 3, or between Version 7 and Version 8, and so on. This feature is designated by the term “Watch Guard”.

The significance of the Watch Guard function is that the two conditions discussed above are most likely to indicate errors or discrepancies. A slide that receives many comments is likely to be the subject of proposed changes. If no such change has been made, the facilitator should check for a possible error. Similarly, it is unlikely for a slide to be changed, but to receive no comments.

In the example shown in FIG. 16, the comparison is between Version 5 and Version 6 of a slide kit. The system has placed a flag on Slide 8, because this slide received numerous comments (illustrated in the upper right-hand portion of the display), but was not changed between versions. The facilitator now has the opportunity to insert a note in the box at the lower right-hand side. In this case, the facilitator's note indicates that the slide was checked manually, and that it is correct.

FIG. 17 illustrates the case in which the system has flagged a slide which has been changed, between Version 5 and Version 6, but for which there are no comments. Again, the facilitator has the opportunity to review the slide manually, and to insert a note indicating that the slide is correct.

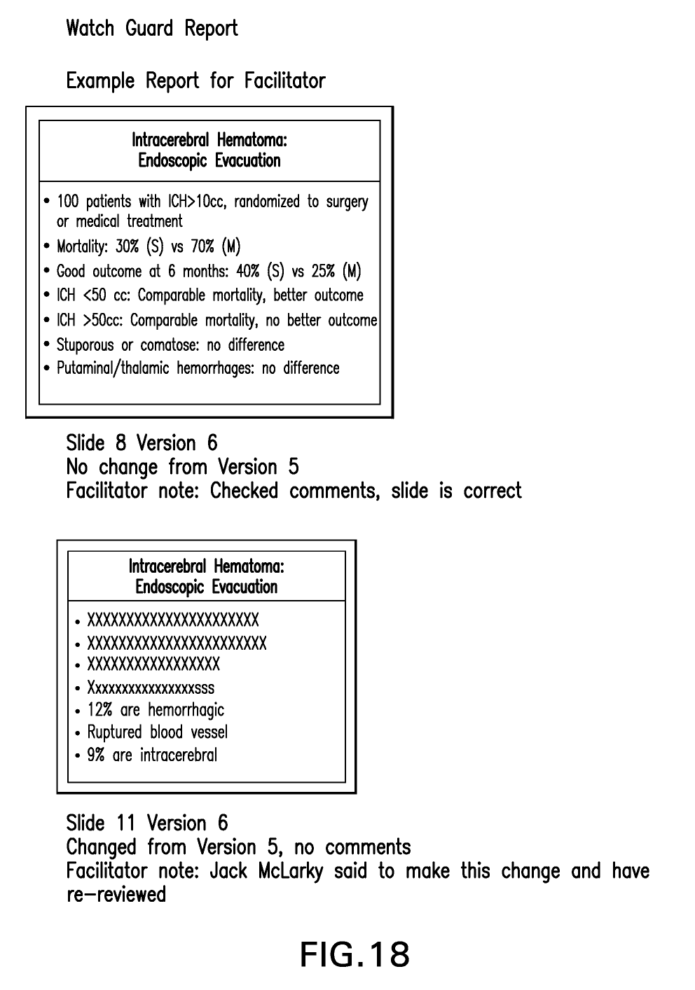

FIG. 18 illustrates a report prepared automatically for the facilitator, by the system of the present invention. The purpose of the report is to display all of the slides flagged for the reasons described above, and to reproduce the notes entered by the facilitator. In the example represented by FIG. 18, Slide 8 of Version 6 is a slide that was not changed from the previous version, but which received a substantial number of comments. Slide 11 of Version 6 was a slide which was changed, but for which there were no comments.

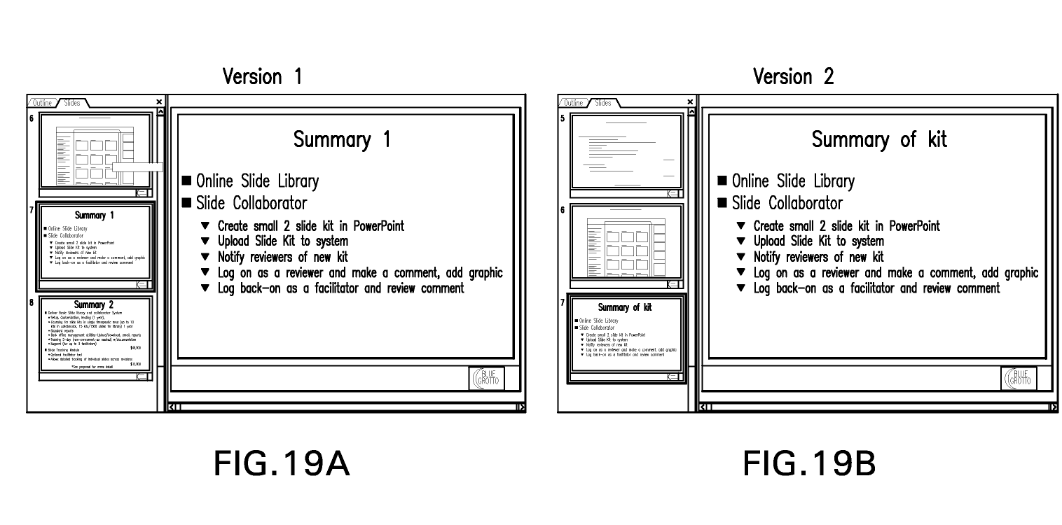

FIGS. 19A, 19B, and 20-23 illustrate another feature of the present invention. With this feature, a user can create internal links, sometimes called “quick links”, between or among various slides.

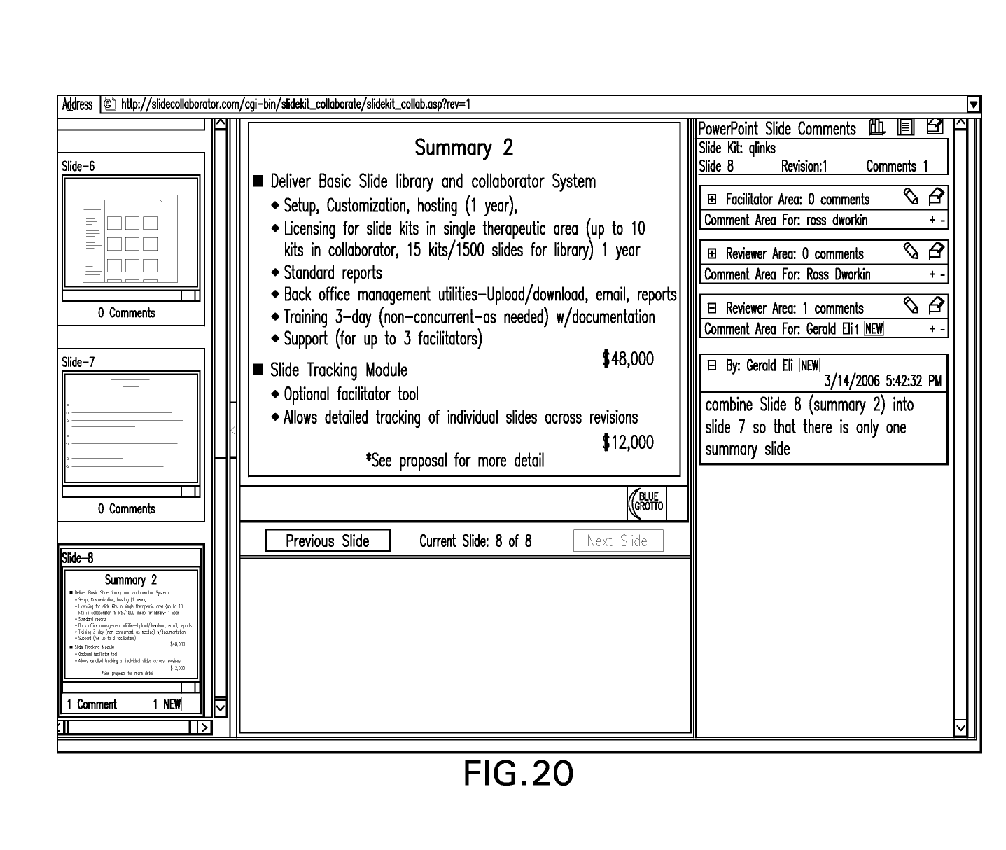

FIGS. 19A, 19B, and 20 depict a hypothetical situation which might trigger the use of the “quick links” feature. In FIG. 19A, it can be seen that Version 1 of the slide kit contains two slides which purport to be “summary” slides, namely Slides 7 and 8. In FIG. 19A, Slide 7 is highlighted on the left-hand column, and is therefore displayed in the large window. In FIG. 20, wherein Slide 8 of Version 1 is highlighted on the left side and displayed in the large window, a reviewer has made a comment (shown on the right-hand side) suggesting that Slide 8 should be combined with Slide 7 so as to present only one summary slide.

FIG. 19B shows the result of the reviewer's suggestion. In FIG. 19B, which represents Version 2 of the kit, Slide 7 (highlighted on the left-hand side and displayed in the large window) represents a new summary slide which has presumably been created using material from the two summary slides in Version 1. The summary slides comprise Slide 7 in both Version 1 (FIG. 19A) and Version 2 (FIG. 19B). The system now enables the user to establish a link between this summary slide, and either or both of the slides from which the summary slide was derived.

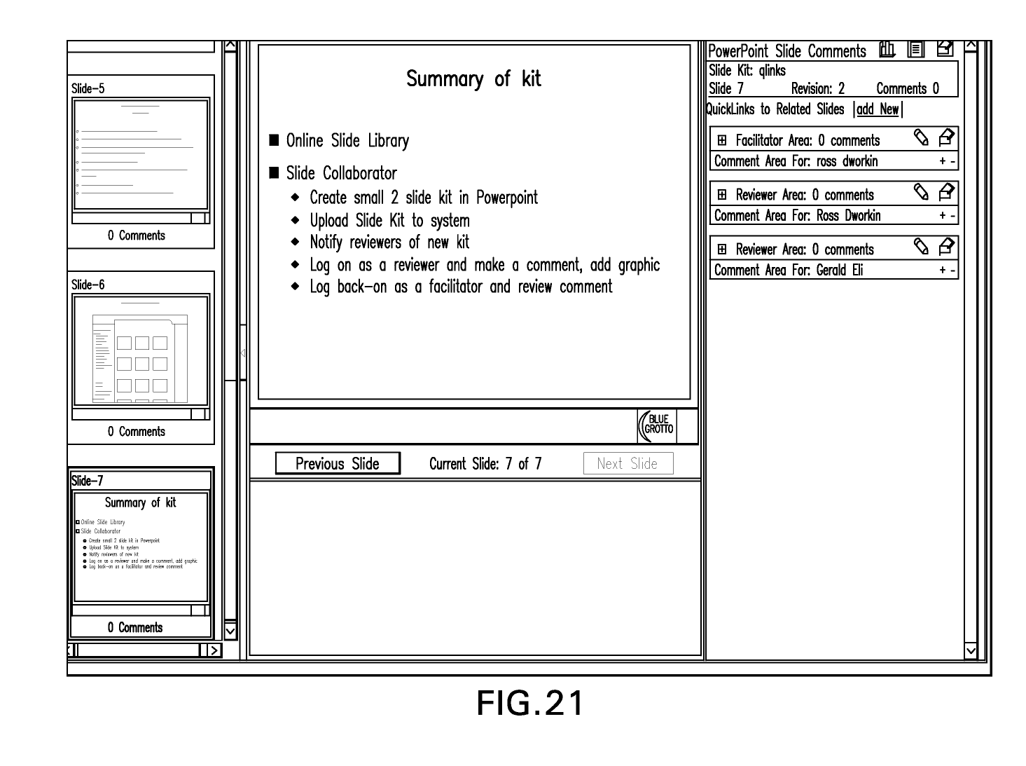

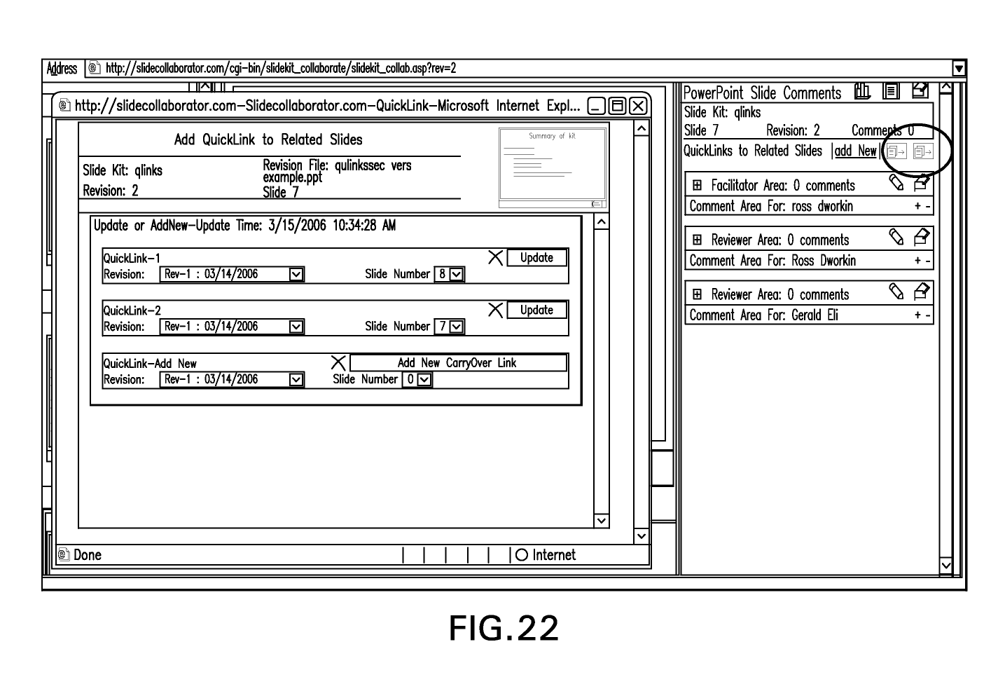

In particular, FIG. 21 shows a display of Version 2, in which Slide 7 has been highlighted on the left side, and displayed in the large central window. The “quick link” feature is identified by the legend “QuickLinks to Related Slides”, shown near the upper right-hand corner. To establish a link with the displayed slide, the user clicks on “add new”. The resulting display is shown in FIG. 22.

FIG. 22 shows a pop-up window labeled “Add QuickLink to Related Slides”. The pop-up window appears in front of the main display of FIG. 21. This pop-up window contains several “drop down” menus, enabling the user to establish “quick links” to various other slides. In the example represented by FIG. 22, the user has entered Slide 8 of Version 1, and also Slide 7 of Version 1. By clicking “Update”, the user establishes the desired links. That is, Slide 7 of Version (or revision) 2 becomes internally linked to Slide 8 of Version 1, and to Slide 7 of Version 1.

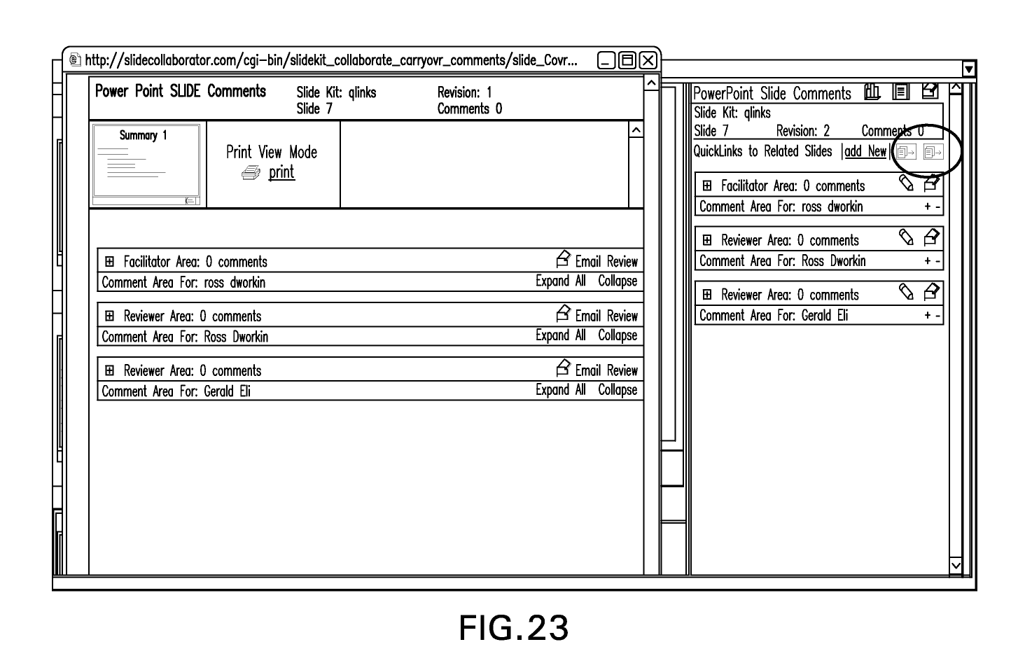

Each time that a “quick link” is established, with respect to a given slide, an icon appears, representing the linked slide, whenever the given slide is shown on the central display. Because, in this example, two such links have been created, two icons appear when the selected slide is displayed. These icons are encircled by the ovals in FIGS. 22 and 23, for emphasis.

Suppose that the user clicks on the second “quick link” icon in FIG. 22. Then the system generates, in a pop-up window shown in FIG. 23, information about the linked slide. In particular, one can see a reproduction of Slide 7 from Version 1, together with information about comments that may have been made concerning this slide. Clicking on the other icon would have produced corresponding information relating to Slide 8 of Version 1.

This “quick links” feature allows users to navigate quickly through various versions of the kit, to view slides that have been deemed related to a given slide. This feature can be used in combination with one or more other features of the invention. Thus, for example, the “quick links” feature could be used instead of, or in addition to, the feature wherein the system automatically generates tables showing the disposition of slides from one version to another. The “quick links” feature can be used instead of, or in addition to, the linking feature represented by FIGS. 5 and 6. The “quick links” feature is a manual linking technique, enhancing the convenience of the system.

Another feature of the present invention concerns the manner of storage of slides. When a slide kit is uploaded to the system, or when a slide is created and stored, the system preferably converts the slide to a generic image format, available to virtually any user. For example, if the slide was created using the PowerPoint program, the slide is stored in a format which does not require the user to have PowerPoint in order to view the slide.

The invention includes not only the methods described above, but also the systems necessary to perform the methods. Such systems preferably include one or more programmed computers, including memory, the computers being programmed to display the various slide kits on a web site that can be accessed by the reviewers. The computer is also programmed to accept comments from the reviewers, and to collate such comments so that the comments are correctly associated with the respective slides, and so that the comment can be easily viewed by other reviewers and/or by the facilitator. The computer may be programmed to generate a diagram, such as is shown in FIG. 5 or 6, indicating the origin or disposition of each slide, in comparing a given version of the slide it with the next version.

As noted above, the slides contemplated by the present invention are not necessarily still images. A slide could be a moving picture, i.e. a video, of any length. In its most general form, a slide kit comprises a plurality of units, each unit being either a still or moving image. What is necessary is that the kit comprise a series of discrete units which can be separately labeled and commented upon.

The invention can be modified in many ways, as explained above. The graphical interfaces shown in the drawings represent only one of many possible implementations of the invention. The various modifications, which will be apparent to those skilled in the art, should be considered within the spirit and scope of the following claims.

What is claimed is:

1. A method of creating a slide kit, comprising:
a) providing a plurality of slides, and making said plurality of slides electronically accessible to a plurality of reviewers,
b) accepting instructions transmitted electronically by at least some of the reviewers, said instructions causing said plurality of slides to be altered, and
c) assembling a modified plurality of slides in response to said instructions received from the reviewers.

2. The method of claim 1, wherein step (b) includes modifying at least one of said plurality of slides.

3. The method of claim 1, wherein step (b) includes adding at least one slide to said plurality of slides.

4. The method of claim 1, wherein step (b) also includes allowing the reviewers to submit comments on particular slides.

5. The method of claim 1, wherein step (b) also includes allowing the reviewers to submit ratings concerning particular slides.

6. The method of claim 4, wherein step (b) also includes allowing the reviewers to submit ratings concerning particular slides.

7. The method of claim 4, wherein the comments submitted by the reviewers include any combination of text and graphics.

8. The method of claim 6, further comprising the step of displaying a summary of all comments and ratings associated with each of said slides.

9. The method of claim 1, wherein steps (b) and (c) are performed a sufficient number of times to create a plurality of versions of a slide kit, and wherein the method further comprises displaying said versions for comparison.

10. The method of claim 9, further comprising the steps of selecting a slide from one of said versions, automatically searching for a similar slide in another version, and displaying said similar slide.

11. The method of claim 10, further comprising creating an internal link between the selected slide and the similar slide in said another version.

12. The method of claim 10, wherein the searching step is performed in all of said versions except the version containing the selected slide.

13. The method of claim 1, wherein steps (b) and (c) are performed separately on at least two distinct slide kits, and wherein the method further comprises displaying said kits for comparison.

14. The method of claim 13, further comprising the steps of selecting a slide from one of said kits, automatically searching for a similar slide in another kit, and displaying said similar slide.

15. The method of claim 14, further comprising creating an internal link between the selected slide and the similar slide in said another kit.

16. The method of claim 15, further comprising generating a report summarizing similarities and differences between slides of said kits.

17. The method of claim 4, further comprising the step of flagging and displaying slides which have been modified but for which there are no comments.

18. The method of claim 4, further comprising the step of flagging and displaying slides which have not been modified and for which there are comments.

19. The method of claim 9, further comprising selecting a slide in a given version, and creating an internal link between the selected slide in the given version and another slide selected from the group consisting of said given version and another version.

20. The method of claim 19, further comprising viewing information on a slide linked to said selected slide, the viewing step being initiated by selecting an icon displayed in conjunction with said selected slide.

21. A method of creating a slide kit, comprising:
a) providing a plurality of slides, and making said plurality of slides electronically accessible to a plurality of reviewers,
b) accepting instructions transmitted electronically by at least some of the reviewers, said instructions causing at least some of said plurality of slides to be altered,
c) displaying at least some of said slides which have been altered,
d) enabling the reviewers to provide separate ratings and separate comments for each of said slides which have been altered, and
e) displaying said altered slides, each altered slide being displayed together with said ratings and said comments submitted by the reviewers.

22. A method of creating a slide kit, comprising:
a) providing a plurality of slides, and making said plurality of slides electronically accessible to a plurality of reviewers,
b) accepting instructions transmitted electronically by at least some of the reviewers, said instructions causing said plurality of slides to be altered, and
c) assembling a revised version of said plurality of slides, according to said instructions received from the reviewers,
d) repeating steps (a) through (c) at least once, so as to create a plurality of versions of a slide kit,
e) displaying at least some of said versions,
f) selecting a slide from one of said versions,
g) automatically searching for slides corresponding to the slide selected in step (f), the searching being conducted in versions other than the version containing the slide selected in step (f), and
h) displaying slides, from different versions, which correspond to each other.

23. A method of creating a slide kit, comprising:
a) providing a plurality of slides, and making said plurality of slides electronically accessible to a plurality of reviewers,
b) accepting inputs from the reviewers, wherein said inputs include alterations of some of said slides or comments on some of said slides, or both,
c) automatically flagging all slides which have been modified but for which there are no comments, and flagging all slides which have not been modified and for which there are comments, and
d) displaying the slides flagged in step (c).
